(19) United States
(12) Patent Application Publication
(10) Pub. No.: US 2010/0257366 A1
(43) Pub. Date: Oct. 7, 2010

(54) METHOD OF AUTHENTICATING A USER

(75) Inventors: Alain Leclercq, Monaco (MC); Yves Arnail, Belmont Sur Rance (FR); Bernard Delbourg, Montpellier (FR)

Correspondence Address: THE NATH LAW GROUP, 112 South West Street, Alexandria, VA, 22314, US

(73) Assignee: MEDISCS (SOCIETE PAR ACTIONS SIMPLIFIEE), Perols (FR)

(21) Appl. No.: 12/746,388

(22) PCT Filed: Dec. 11, 2008
(86) PCT No.: PCT/FR08/52280

§ 371 Date: Jun. 4, 2010

(30) Foreign Application Priority Data
Dec. 11, 2007 (FR) 07 59714
Jan. 21, 2008 (FR) 08 50367

(51) Int. Cl. H04L 9/32

(52) U.S. Cl. 713/173

(57) ABSTRACT

The invention relates to a method for authenticating a user (1) on the basis of a mobile terminal of the cellular phone type (2), in which said user (1) views through a browser a portal for accessing a service hosted on a server (4); said user (1) requests his authentication through the browser via said portal; said portal initiates a pre-session in such a way as to display, through said browser, temporary access data (5) independent from said user (1); said user (1) inputs into his telephone (2) the data viewed; said telephone (2) automatically dispatches a request (6) to said server (4), including at least one authentication certificate (7) specific to the user (1) and said viewed data (5); said request (6) is encrypted with the aid of the public key of a certificate (8) of said server (4) and, in the event of authentication of the user (1), access to the service is authorized through a secure session in the browser.

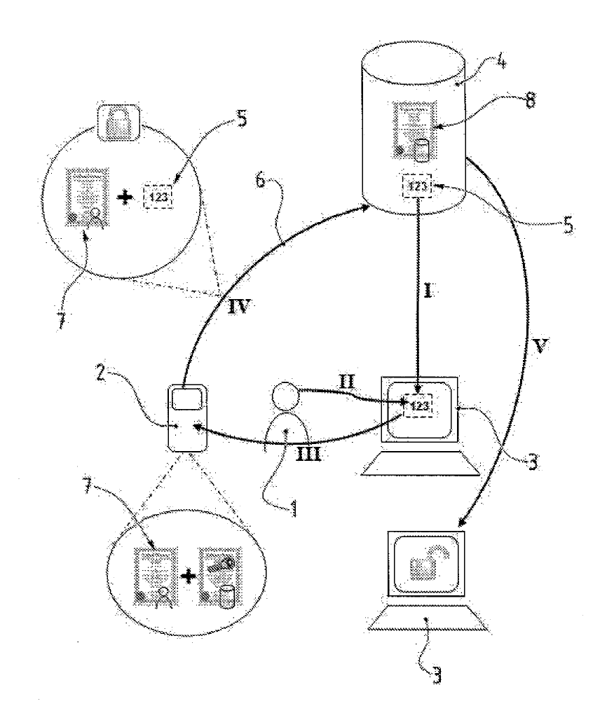

### BACKGROUND OF THE INVENTION

(1) Field of the Invention

This invention is related to the field of authenticating a user on the basis of a terminal, in particular on the basis of a cellular phone.

The invention relates more specifically to a method for the strong authentication of a user on the basis of a terminal of the cellular phone type.

This invention will find a specific application within the framework of the request for a remote and secure access by a user, from a mobile phone, to a service hosted on a server, in particular through a portal displayed through a browser.

It falls within the framework of a connection through a computer and telecommunication network of the Internet type, in particular through <<WAP>> (standing for <<Wireless Application Protocol>>). WAP is a communication network the purpose of which is to allow access to the Internet with the help of a mobile terminal, such as a cellular phone, a PDA or the like.

(2) Description of the Prior Art

In a known manner, the remote and secure access to a service occurs through a browser, displaying an access portal that the user can view. The secure aspect of this access requires authentication of said user. Two techniques are generally adopted in order to verify with certainty the identity of the person wishing to connect to said service.

On the one hand, on request by the user, a message can be sent to his phone through short message services (or sms for <<short message service>>). This message contains connection data, in particular a valid code for one or more accesses. Being in possession of said access code, the user inputs the latter during an identification request at the time of his connection to the service and then a session is opened. Such a code can be used only once or repeatedly.

One disadvantage resides in the complete absence of security at the level of the sms service. No protection is provided, making it absolutely possible for a third person to intercept the code during its transmission or its reception.

Another solution is based on the <<TOKEN>> principle, i.e. generation of synchronized numbers with an authentication device. Still on request by said user, an access key is generated and sent to the phone. A time synchronization occurs before or at the time of the connection attempt. The key is then exchanged with the remote service during a manual or automatic identification stage. This key is only valid for one single use.

In this context, a exemplary protocol is described in WO 01/17310. A user wishing to access a remote service connects to a portal through a computer via a browser. He is identified through a procedure of inputting a log-in and/or a password. A request is then sent to the remote server, which identifies the phone number corresponding to said user and sends, on the one hand, an authentication request to the browser integrating a first token and, on the other hand, a message to the phone including a second token. The user then inputs the first token into his phone and returns to the server a message automatically integrating the second token. By comparison, the server authenticates said user and gives him access to said service.

A first disadvantage resides in the multiplication of the requests sent, increasing the underlying procedures and the costs related thereto. In particular, the user should also be identified once beforehand for the setting up of the authentication procedure.

Within the framework of the <<TOKEN>> technology, the OTP (standing for <<One Time Pad>>) protocol is known, also called <<disposable mask>>, using a list of single-use dynamic passwords. The OTP lists are shared by the two protagonists of the secure connection to be established. The codes are used in the established order. Upon each issuance of a password of a list A, it is verified, then crossed out in a list B.

Anyway, the data transmission generally occurs through a WAP network to the Internet. One problem resides in that the secure protocols of either of said networks are different: WTLS and SSL. The gateway is then constrained to decrypt the data in WTLS in order to encode them again under SSL.

In addition, there is absolutely no way to make sure that the connection is carried out on the original server, making it possible to mislead the user through a false server.

Other solutions have been considered, but they do not give full satisfaction. Indeed, the user is always constrained to identify himself by sending an access request, through a key or a connection code before being able to access said service.

In addition, there is no solution allowing the use of an electronic signature of documents after authentication.

### SUMMARY OF THE INVENTION

The object of the invention is to cope with the disadvantages of the state of the art by providing the authentication of the user in a secure and strong manner on the basis of his mobile phone.

Beside the high level of security, the protocol according to the invention simplifies the strong authentication of said user. In addition, it permits the electronic signature of data such as documents, electronic mail or the like.

To this end, this invention relates to a method for authenticating a user on the basis of a mobile terminal of the cellular phone type, in which:
said user views through a browser a portal for accessing a service hosted on a server;
said user requests his authentication through the browser via said portal;
said portal initiates a pre-session so as to display, through said browser, temporary access data independent from said user;
said user inputs into his phone the data viewed;
said phone automatically dispatches a request to said server, including at least one authentication certificate specific to the user and said viewed data;
said request is encrypted by means of the public key of a certificate of said server and, in the event of authentication of the user, the access to the service is authorized through a secure session within the browser.

According to further features, after authentication of said user, said browser automatically displays said secure session.

Advantageously, through the session displayed by said browser, the user views at least one document to be signed; each document to be signed is listed and said list is transmitted to said phone; said phone retrieves from said server all or part of the documents to be signed; and thanks to the key of one of the certificates it contains, said phone electronically signs the documents chosen by the user and sends back said signatures to said server.

In addition, said browser is executed on a separate terminal such as a computer.

Such an authentication protocol offers an utterly different alternative in as much as the user wishing to access a remote service via a portal displayed on a browser does not have to identify himself in the browser. Indeed, the invention sends identification data to the browser without taking into account the identity of the user. Said identity will automatically be confirmed during the authentication by the phone.

Therefore, another advantage resides in that the invention permits both the identification and the authentication of the user on the basis of one single terminal, in particular a phone, yet limiting the number of connection and request dispatches, thus considerably reducing the security risks.

### BRIEF DESCRIPTION OF THE DRAWING

Further features and advantages of the invention will become evident from the following detailed description of the non-restrictive embodiments of the invention, with reference to the attached figure representing schematically the architecture and the evolution of the stages of an embodiment of said authentication protocol.

### DETAILED DESCRIPTION OF THE PREFERRED EMBODIMENTS

This invention allows a strong authentication of a user 1 wishing to connect in a secure manner to a remote service by means of a mobile terminal 2, in particular a cellular phone 2, whereas the utilization of the remote service itself occurs through a browser, in particular executed by means of another computer terminal 3, for example a computer.

One should distinguish, on the one hand, the computer terminal 3 through which the user 1 accesses said service and navigates and, on the other hand, the cellular phone 2 from which he is authenticated, said computer 3 and said phone 2 being different.

Furthermore, it should be noted that said service is hosted on a server 4, more specifically on a web server connected to a computer network such as the Internet. This service is accessible on-line through a portal.

In a known manner, said portal is displayed on any type of terminal through a browser. This terminal can be said computer 3 connected to said Internet network, but also another fixed or mobile terminal. Thus, the user 1 views the data transmitted from the server 4 to the browser.

The user 1 therefore views the portal for accessing said service. By navigating, he makes an authentication request via said portal, in particular through a web page dedicated for this purpose.

Then, said portal initiates a pre-session. The latter is unique and is created dynamically with temporary access data. Therefore, each request by a user 1 corresponds to a unique pre-session with unique access data, specific to each request.

As shown in the figure, said data are transferred from said server 4 through a first stage I. The connection between the computer 3 and said server 4 can then be made secure.

Said data can be in the form of an identifier 5, in particular one or more access codes or the like. They are displayed in the browser so that the user 1 can view them (stage II).

It should be noted that said temporary data are independent from said user 1. In other words, the portal does not take into account the identity of the user 1: it issues automatically an identifier 5 without identifying the person wishing to access the service.

Once displayed, during stage III, the user 1 inputs into his phone 2 said data, more specifically the identifier 5, in particular through an application dedicated to said service and included at the level of said phone 2.

Thus, each dedicated application contains the connection data of each service to which it is connected, for example the addresses (URL or the like) of said server 4. This application can advantageously be coded in JAVA language, portable and compatible with numerous heterogeneous platforms.

Afterwards, said phone 2 automatically dispatches a request 6 to said server 4, stage 1V. This request 6 includes at least one authentication certificate 7 specific to the user 1. The request 6 is encrypted with the public key contained in the certificate 8 of said server 4. The latter is known through said dedicated application. The certificate 7 of the user 1 is also contained in said phone 2 or through an additional terminal. For example, said certificate 7 of the user 1 can be stored on the SIM card of the phone 2 or on a cryptographic chip.

The request 6 can also include the data previously displayed and input into the phone 2, in particular the identifier 5. Said data can also be used for the encryption of the request 6, by means of the key of said server 4.

Therefore, only said server 4, having the private key of its own certificate 7, is able to decrypt the request 6 it receives.

Upon reception of the request 6, said server 4 verifies the certificate 7. In the event of authentication of the user 1, the access to the service is authorized through a secure session. The latter can then automatically be displayed in said browser, as shown in stage V.

It should be noted that the authentication of the user 1 by the server 4 can also include a stage for acknowledging said authentication by the browser. This acknowledgement can be made by the user, who confirms that the opened session corresponds with certainty to his personal identity.

This acknowledgement can also occur through said phone 2, in particular by data transmitted as a feedback of the request 6. Indeed, the communication protocol used for the transmission of said request 6 to the server 4 can include feedback data, in particular in order to confirm the status of the transmission and whether the request 6 has reached said server 4. Therefore, in said data additional identification data can be transmitted as a feedback to the phone 2. The user will then be able to input them through said browser, in order to validate the secure session.

The user 1 can then navigate on the access portal at will, certain of being connected to the genuine service. On the other hand, the service is certain that the connected user 1 is the right one.

During this navigation, thanks to the presence of certificates, the user 1 can operate the electronic signature of documents contained via said portal on said server 4. For example, the user 1 can access an electronic mail service and decide to send e-mails signed electronically.

To this end, said user 1 views at least one document to be signed through the session displayed by said browser. Since the electronic signature of this user 1 is stored in said phone 2, each document to be signed is listed and said list is transmitted to said phone 2. Upon reception, said phone 2 sends to said server 4 the certificates and electronic signature necessary for the signing of each document.

Therefore, the authentication method according to the invention offers an increased security during the remote connection to a service, through a cellular phone 2 and via a browser on a separate terminal, in particular a computer 3.

The invention is also based on a combination of identification and authentication stages on said phone 2, thus providing an increased security.

In addition, the remote electronic signing via the cellular phone 2 is made possible.

The advantage of this invention resides in the strong aspect of authentication and of the high level of security provided through the interoperability between the mobile communication network and the Internet network, without leaving any security flaws.

The invention is of course not limited to the examples shown and described previously, which can have variants and modifications without departing from the scope of the invention.

1. Method for authenticating a user (1) on the basis of a mobile terminal of the cellular phone type (2), in which:
said user (1) views through a browser a portal for accessing a service hosted on a server (4);
said user (1) requests his authentication through the browser via said portal;
said portal initiates a pre-session so as to display, through said browser, temporary access data (5) independent from said user (1);
said user (1) inputs into his phone (2) the data viewed;
said phone (2) automatically dispatches a request (6) to said server (4), including at least one authentication certificate (7) specific to the user (1) and said viewed data (5);
said request (6) is encrypted by means of the public key of a certificate (8) of said server (4) and, in the event of authentication of the user (1), the access to the service is authorized through a secure session in the browser.

2. Method according to claim 1, wherein after the authentication of said user (1), said browser automatically displays said secure session.

3. Method according to claim 2, wherein:
through the session displayed by said browser, the user (1) views at least one document to be signed;
each document to be signed is listed and said list is transmitted to said phone (2);
said phone (2) retrieves from said server (4) all or part of the documents to be signed; and
thanks to the key of one of the certificates it contains, said phone (2) electronically signs the documents chosen by the user (1) and sends back said signatures to said server (4).

4. Method according to claim 1, wherein said browser is executed on a separate terminal of the computer (3) type.

5. Method according to claim 2, wherein said browser is executed on a separate terminal of the computer (3) type.

6. Method according to claim 3, wherein said browser is executed on a separate terminal of the computer (3) type.

7. Method according to claim 4, wherein said browser is executed on a separate terminal of the computer (3) type.
